(19) United States
(12) Patent Application Publication
(10) Pub. No.: US 2025/0098830 A1
(43) Pub. Date: Mar. 27, 2025

(54) MAGNETIC DOCKING AND UNDOCKING

(71) Applicant: Google LLC, Mountain View, CA (US)

(72) Inventors: Emily Sun, San Jose, CA (US); Ethan Graves, Santa Clara, CA (US); Amy Lai Wong, Newark, CA (US)

(73) Assignee: Google LLC, Mountain View, CA (US)

(21) Appl. No.: 18/471,515

(22) Filed: Sep. 21, 2023

(51) Int. Cl. A45C 11/00; A45C 13/10; G06F 1/16

(52) U.S. Cl. CPC A45C 11/00; A45C 13/1069; G06F 1/1632; A45C 11/003

(57) ABSTRACT

A method for docking a tablet computer to a tablet computer case includes magnetically coupling a first pivot magnet of the tablet computer case to a second pivot magnet of the tablet computer, pivoting the tablet computer toward the tablet computer case, and magnetically coupling a first plurality of docking magnets of the tablet computer case to a second plurality of docking magnets of the tablet computer. The first pivot magnet magnetically couples to the second pivot magnet prior to the first plurality of docking magnets magnetically coupling to the second plurality of docking magnets. A tablet computer case system includes a tablet computer case including a first portion and a second portion. The tablet computer case includes a first plurality of docking magnets arranged on the first portion and a first pivot magnet arranged along a perimeter of the first portion opposite the hinge.

### BACKGROUND

Tablet computers may be removably docked from tablet computer cases. Tablet computer cases are designed to replicate the user experience of a laptop system while providing additional functionality and portability. A tablet computer case having a tablet computer docked to the tablet computer case may have unique geometries and weight distribution compared to a laptop system.

### SUMMARY

According to one embodiment, a method for docking a tablet computer to a tablet computer case includes magnetically coupling a first pivot magnet of the tablet computer case to a second pivot magnet of the tablet computer, pivoting the tablet computer toward the tablet computer case, and magnetically coupling a first plurality of docking magnets of the tablet computer case to a second plurality of docking magnets of the tablet computer. The first pivot magnet magnetically couples to the second pivot magnet prior to the first plurality of docking magnets magnetically coupling to the second plurality of docking magnets.

The method may include various optional embodiments. The method may further include undocking the tablet computer from the tablet computer case including magnetically decoupling the second plurality of docking magnets of the tablet computer from the first plurality of docking magnets of the tablet computer case, pivoting the tablet computer toward the tablet computer case, and magnetically decoupling the first pivot magnet of the tablet computer case from the second pivot magnet of the tablet computer case. The first plurality of docking magnets may magnetically decouple from the second plurality of docking magnets prior to the first pivot magnet magnetically decoupling from the second pivot magnet. The first pivot magnet may be arranged proximate to a topmost edge of the tablet computer case. A portion of the tablet computer case proximate to the topmost edge of the tablet computer case may be a first point of contact for docking the tablet computer to the tablet computer case. The portion of the tablet computer case proximate to the topmost edge of the tablet computer case may be a pivot point for undocking the tablet computer from the tablet computer case. The method may further include closing the tablet computer case such that a latching magnet of the tablet computer case arranged opposite the first pivot magnet and the second pivot magnet magnetically couples to the first pivot magnet and the second pivot magnet to latch the tablet computer case in a closed position.

According to another embodiment, a tablet computer case system includes a tablet computer case including a first portion and a second portion including a keyboard. The second portion moves relative to the first portion. The tablet computer case includes a hinge for rotationally adjusting a position of the first and second portions relative to one another between an open position and a closed position, a first plurality of docking magnets arranged on the first portion, and a first pivot magnet arranged along a perimeter of the first portion opposite the hinge. After the first plurality of docking magnets have been disengaged from magnetically coupling with a tablet computer, the first pivot magnet remains engaged with the tablet computer to cause the tablet computer to rotate with respect to the first portion.

The tablet computer case system may include various optional embodiments. The tablet computer case system may include a tablet computer that can be removably docked from the first portion of the tablet computer case. The tablet computer may include a second plurality of docking magnets arranged to magnetically couple to the first plurality of docking magnets and a second pivot magnet arranged to magnetically couple to the first pivot magnet. The tablet computer case system may include a latching magnet arranged on the second portion. The first pivot magnet may be arranged to magnetically couple to the second pivot magnet on the tablet computer. The second pivot magnet may be stacked between the first pivot magnet and the latching magnet when the tablet computer is docked to the tablet computer case and the tablet computer case is in the closed position. The first pivot magnet may enable a two-part docking and undocking of the tablet computer from the tablet computer case. The tablet computer case may include an outer covering surrounding the hinge and the first and second portions, the outer covering forming a support feature while in the open position. The tablet computer case may include an access feature on each side of the first portion. A gap to facilitate undocking may be formed between the support feature and the access feature when the tablet computer case is in the open position. The tablet computer case may include at least two first pivot magnets and the tablet computer may include at least two second pivot magnets.

According to yet another embodiment, a tablet computer case includes a first portion that is removably dockable with a tablet computer, a second portion comprising a keyboard, the second portion configured to move relative to the first portion, a hinge for rotationally adjusting a position of the first and second portions relative to one another between an open position and a closed position, a first plurality of docking magnets arranged on the first portion to magnetically couple to a second plurality of docking magnets on the tablet computer, and a first pivot magnet arranged along a perimeter of the first portion opposite the hinge to magnetically couple with a second pivot magnet on the tablet computer.

The tablet computer case may include various optional embodiments. The tablet computer case may include a latching magnet arranged on the second portion. The first pivot magnet may be arranged to magnetically couple to a second pivot magnet on the tablet computer. The second pivot magnet may be stacked between the first pivot magnet and the latching magnet when the tablet computer is docked to the tablet computer case and the tablet computer case is in the closed position. The first pivot magnet may enable a two-part docking and undocking of the tablet computer from the tablet computer case.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates a block diagram of an embodiment of a tablet computer case system.

FIG. 2 illustrates an embodiment of a tablet computer case system.

FIG. 3 illustrates an embodiment of a tablet computer case having a first plurality of docking magnets and first pivot magnets.

FIG. 4 illustrates an embodiment of a tablet computer case having a second plurality of docking magnets and second pivot magnets.

FIG. 5A is a perspective view of an embodiment of a tablet computer mid-docking/undocking from a tablet computer case.

FIG. 5B is a side view of an embodiment of a tablet computer mid-docking/undocking from a tablet computer case.

FIG. 6 is a side view of an embodiment of a tablet computer docked in a tablet computer case when the tablet computer case is in a closed position.

FIG. 7A illustrates a flowchart of an embodiment of a method.

FIG. 7B illustrates a flowchart of an embodiment of a method.

### DETAILED DESCRIPTION

Portable electronic devices such as tablet computers often benefit from the use of an accessory device such as a tablet computer case, which can have a keyboard and/or a trackpad. A tablet computer may be removably dockable from a tablet computer case, thereby providing the user the flexibility of using the tablet computer as an individual portable electronic device or using the tablet computer as a laptop where the tablet computer case includes a keyboard and, possibly, a trackpad.

Various tablet computer cases detailed herein may employ magnet attachment mechanisms for docking and undocking a tablet computer. A poorly tuned magnet layout design can lead to difficulty docking and undocking the tablet computer as well as increased potential for failed electrical connections due to poor alignment. Poor alignment affects the functionality, ease of use, and the perceived quality of the product.

Embodiments of the present disclosure include a tablet computer case system. A tablet computer case system may include a tablet computer that is removably dockable to a tablet computer case. A tablet computer case and a tablet computer can include corresponding pivot magnets, in addition to attachment magnets, for improving a user experience while docking the tablet computer to, and undocking the tablet computer from, the tablet computer case. Rather than having all magnets engage and disengage at the same time, the tablet computer case system described herein concentrates magnetic force at the top edge of the tablet computer case to serve as a pivot point and early attachment point for the tablet computer. The concentration of magnetic force enables a user to grasp the tablet computer and undock the tablet computer from, or dock the tablet computer to, the tablet computer case quickly, with one hand, at various angles, etc. The pivot magnets help create an assisted “hinged” docking and undocking motion. According to some embodiments, cutouts in the tablet computer case further facilitate a smooth docking and undocking experience.

The embodiments detailed herein are focused on a tablet computer case. An electronic device for use with the tablet computer case is removably dockable to the tablet computer case. In some embodiments, the electronic device is a tablet computer that is a component of a tablet computer case system. Specifically, a tablet computer can serve as a home assistant device and/or hub to manage smart home devices in an environment. The tablet computer may be able to record video, communicate with a remote server system, and interact with users via spoken communications. For example, a home assistant device may provide automated control or voice control of devices, appliances, and systems, such as heating, ventilation, and air conditioning (“HVAC”) system, lighting systems, home theater, entertainment systems, as well as security systems. Smart home networks may include control panels that a person may use to input settings, preferences, and scheduling information that the smart home network uses to provide automated control of the various devices, appliances, and systems in the home. For example, the person may input a schedule indicating when the person is away from the home, and the smart home network uses this information along with information obtained from various devices in the home to detect unauthorized entry when the user is away. The tablet computer may be left docked with a dock or a tablet computer case to charge its battery and use other features of the dock or tablet computer case, such as an integrated speaker. The tablet computer may be removed from the dock for convenience to be used or displayed at another location, such as on a tablet computer case. When not in use (whether docked, not docked, or both), photos or photo albums selected by a user may be presented by the tablet computer.

Many other types of electronic devices can benefit from a tablet computer case having an extendable tipping point configuration described herein. For example, smartphones, gaming devices, e-readers, personal digital assistants (PDAs), digital paper tablets, and smart picture frames may benefit from various embodiments a docking case as detailed herein. Furthermore, the electronic device may be an assistant device (e.g., Google® Nest® Hub; Google® Nest® Hub Max); a home automation controller (e.g., controller for an alarm system, thermostat, lighting system, door lock, motorized doors, etc.); a gaming device (e.g., a gaming system, gaming controller, data glove, etc.); a communication device (e.g., a smart phone such as a Google® Pixel® Phone, cellular phone, mobile phone, wireless phone, portable phone, radio telephone, etc.); and/or other computing device (e.g., a tablet computer such as the Pixel® Tablet, phablet computer, notebook computer, laptop computer, etc.).

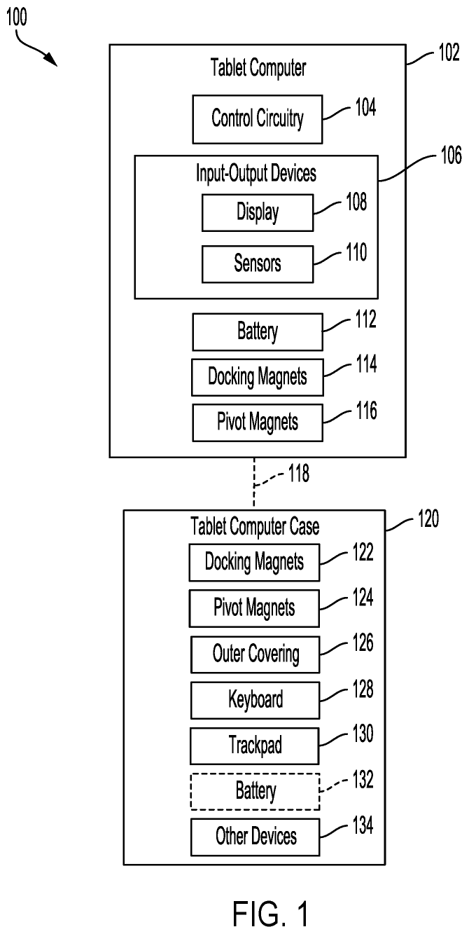

FIG. 1 illustrates a block diagram of an embodiment of a tablet computer case system. A tablet computer case system 100 includes a tablet computer 102 and a tablet computer case 120. As shown in FIG. 1, a tablet computer 102 may have control circuitry 104. Control circuitry 104 may include storage and processing circuitry for supporting the operation of tablet computer 102. The storage and processing circuitry may include storage such as hard disk drive storage, nonvolatile memory (e.g., flash memory or other electrically-programmable-read-only memory configured to form a solid state drive), volatile memory (e.g., static, or dynamic random-access-memory), etc. Processing circuitry in control circuitry 104 may be used to control the operation of tablet computer 102. The processing circuitry may be based on one or more microprocessors, microcontrollers, digital signal processors, baseband processors, power management units, audio chips, application specific integrated circuits, etc.

Input-output devices 106 may be used to allow data to be supplied to tablet computer 102 and to allow data to be provided from tablet computer 102 to external devices. Input-output devices 106 may include a display 108 for displaying images to a user and other devices such as buttons, joysticks, scrolling wheels, touch pads, keypads, keyboards, microphones, speakers, tone generators, vibrators and other haptic output devices, light-emitting diodes and other status indicators, data ports, etc. Input-output devices 106 may also include sensors 110. Sensors 110 may include cameras (e.g., visible light and/or infrared image sensors), ambient light sensors, proximity sensors, orientation sensors, magnetic sensors (e.g., Hall effect sensors, magnetometers that serve as compasses, etc.), strain gauges and other force sensors, touch sensors, pressure sensors, fingerprint sensors, gas sensors, depth sensors such as structured light sensors, and other sensor circuitry. A user can control the operation of tablet computer 102 by supplying commands through input-output devices 106 and may receive status information and other output from tablet computer 102.

Control circuitry 104 may be used to run software on tablet computer 102 such as operating system code and applications. During operation of tablet computer 102, the software running on control circuitry 104 may capture and process touch sensor information gathered with the touch sensor formed from sensors 110. Based on this information, control circuitry 104 may take suitable action, such as adjusting images displayed on display 108, adjusting the operation of sensors 110, placing circuitry in tablet computer 102 in a low-power sleep state to conserve power, waking circuitry that is in a sleep state, and/or other actions associated with controlling the operation of tablet computer 102.

Tablet computer 102 may receive wireless power from a wireless power transmitter and/or may receive wired power from a power adapter that is coupled to tablet computer 102 with a cable. Power that is received by tablet computer 102 may be used to charge a battery 112. During portable operation, a battery 112 may be used to power the circuitry of tablet computer 102. Battery power for powering the tablet computer 102 may also be provided by a supplemental battery in tablet computer case 120 (e.g., optional battery 132). In some embodiments, the tablet computer 102 may power the tablet computer case 120. The tablet computer case 120 and the tablet computer 102 may communicate via a wired and/or wireless communications link 118.

The tablet computer 102 includes a plurality of docking magnets 114 for magnetically coupling the tablet computer 102 to the tablet computer case 120. The tablet computer case 120 includes corresponding docking magnets 122 that the docking magnets 114 magnetically couple to when the tablet computer 102 is magnetically docked to the tablet computer case 120. The tablet computer 102 also includes a pivot magnet 116 configured to act as a first contact point and as a pivot point during docking and undocking, respectively, of the tablet computer 102 from the tablet computer case 120. The tablet computer case 120 includes a corresponding pivot magnet 124.

Tablet computer case 120 includes an outer covering 126 for forming a support structure that extends a tipping point of the tablet computer case 120. The outer covering 126 may include a uniform material stack throughout the outer covering 126 such that no creases are formed when alternating a position of the tablet computer case 120 between an open position and a closed position.

Tablet computer case 120 includes a keyboard 128 and a trackpad 130 for providing input to the tablet computer 102 when the tablet computer 102 is docked to the tablet computer case 120. For example, the tablet computer case 120 may include a keyboard 128 and a trackpad 130 on a bottom portion or base of the tablet computer case 120 to simulate a laptop experience for a user.

Tablet computer case 120 may include other devices 134 (e.g., additional components such as input-output devices, control circuitry, a display, force sensors and other sensors, status indicator lights, keyboard keys, buttons, and/or other input-output devices). Other devices may include control circuitry, wireless communications circuitry (e.g., radio-frequency transceiver circuitry and antenna(s)) and/or wired communications circuitry, storage, and processing circuitry, etc.

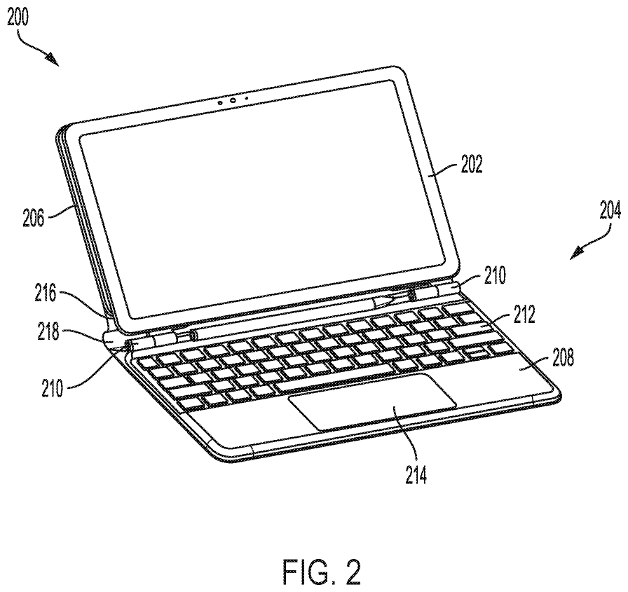

FIG. 2 illustrates an embodiment of a tablet computer case system. The tablet computer case system 200 includes a tablet computer 202 that is removably dockable to a tablet computer case 204. The tablet computer case 204 includes a first portion 206 and a second portion 208. The first portion 206 may alternatively be referred to as a lid or a top portion. The second portion 208 may alternatively be referred to as a base or a bottom portion. The second portion 208 is configured to move relative to the first portion 206 and vice versa. The first portion 206 and the second portion 208 are rotationally adjustable using one or more hinges 210 such that the tablet computer case 204 transitions from an open position to a closed position. As shown in FIG. 2, the tablet computer case 204 is in the open position. The second portion 208 includes a keyboard 212 and a trackpad 214 for a user to provide input to the tablet computer 202, in manner which would be understood by one having ordinary skill in the art upon reading the present disclosure.

In at least some embodiments, the hinge 210 is a rigid hinge. For example, a rigid hinge is able to retain an opening angle and/or position within a preset range when a force is applied to the rigid hinge and/or the components the rigid hinge is coupled to. A rigid hinge is capable of supporting itself in an opening angle without any aid external to the rigid hinge. A rigid hinge may use friction to resist motion according to at least some embodiments. A rigid hinge is in contrast to a soft hinge which cannot itself support an opening angle (e.g., an outer covering of a soft hinge folds on itself and may use magnets or other folding configurations to support an opening angle and position). In at least some embodiments, the hinge 210 is a rigid hinge set to support a maximum moment in an angle range (e.g., between 0 degrees and 130 degrees, inclusive), at 3.3 kgf/cm²+/−10% tolerance.

The tablet computer case 204 includes an outer covering 216 surrounding the hinge 210 and the first portion 206 and the second portion 208. In various embodiments, the outer covering 216 is a uniform material stack throughout the outer covering 216 that forms the support feature 218 while in the open position that extends a tipping point of the tablet computer case beyond the hinge while in the open position. For example, the portion of the outer covering 126 that forms the support feature is uniform through the support feature up to where the outer covering 126 attaches to the first portion 206 and where the outer covering 126 attaches to the second portion 208. For example, there is no transition of material or pre-made creases along the outer covering 216. The uniform stack material may include a polycarbonate sheet disposed between at least two polyurethane sheets. In various embodiments, the at least two polyurethane sheets include a knit backer. In some embodiments, the uniform material stack includes a 0.4 mm polyurethane sheet with a knit backer, a 0.1 mm polycarbonate sheet, 0.1 mm of adhesive, and another 0.4 mm polyurethane sheet with a knit backer. The material stack provided herein does not substantially change shape over time of use or during extended time periods in the open position or in the closed position.

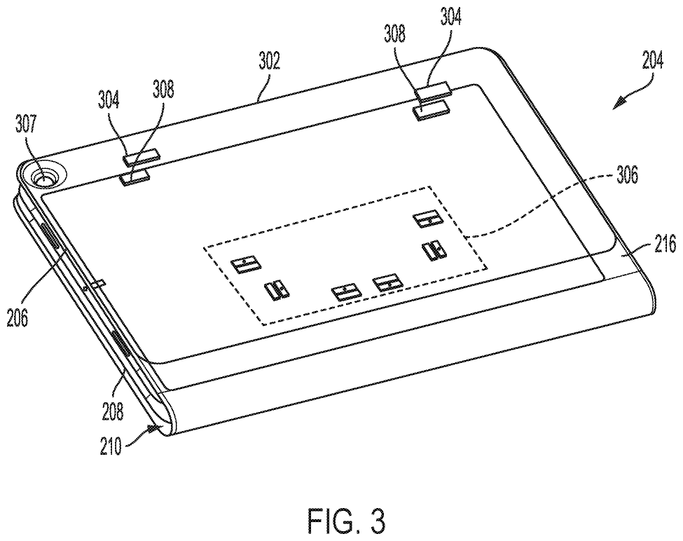

FIG. 3 illustrates an embodiment of a tablet computer case having a first plurality of docking magnets and first pivot magnets. The description of tablet computer case system 200 described in relation to FIG. 2 is applicable to the tablet computer case having a first plurality of docking magnets and first pivot magnets. As shown, the tablet computer case 204 is in the closed position having the first portion 206 parallel to the second portion 208 and the outer covering 216 flush with the first portion 206 and the second portion 208. The tablet computer case 204 includes a topmost edge 302 opposite the hinge 210. In this view of the tablet computer case 204, the first portion 206, the second portion 208, and the outer covering 216 are transparent to show the magnet configuration integrated into the first portion 206 and the second portion 208.

According to various embodiments, the first portion 206 of the tablet computer case 204 includes a first pivot magnet 304 arranged along a perimeter of the first portion 206. In particular, the tablet computer case 204 includes a first pivot magnet 304 arranged proximate to the topmost edge 302 of the first portion 206 opposite the hinge 210. For example, the first pivot magnet 304 may be arranged on a portion of the tablet computer case 204 proximate to the topmost edge 302. According to at least some embodiments, the first portion 206 includes at least two first pivot magnets 304, as shown in FIG. 3. In other embodiments, the tablet computer case 204 may include any number of first pivot magnets 304 along a portion of the tablet computer case 204 proximate to the topmost edge 302 of the first portion 206. The first pivot magnets 304 are configured to magnetically couple with corresponding second pivot magnets of a tablet computer, to be described in further detail below, when the tablet computer is docked to the tablet computer case 204. For example, the first pivot magnets 304 magnetically couple with second pivot magnets of the tablet computer when the tablet computer is docked to the first portion 206 of the tablet computer case 204.

The first pivot magnets 304 act as the first points of contact (e.g., an early attachment point) for a tablet computer being docked to the tablet computer case 204. The first pivot magnets 304 provide a concentrated magnetic force which initially draws the tablet computer toward the tablet computer case 204. According to at least some embodiments of the present disclosure, the first pivot magnets 304 provide additional concentrated magnetic force proximate to the topmost edge 302 of the first portion 206 of the tablet computer case 204. In various embodiments, the magnetic force for assisted docking provided by the first pivot magnets 304 is between 20 N and 25 N, inclusive. In at least some embodiments, the magnetic force for assisted docking provided by the first pivot magnets 304 is 20 N.

In various embodiments, the first portion 206 includes a first plurality of docking magnets 306 arranged on the first portion 206. The first plurality of docking magnets 306 are configured to magnetically couple with a second plurality of docking magnets of a tablet computer, to be described in further detail below, when the tablet computer is docked to the tablet computer case 204. For example, the first plurality of docking magnets 306 magnetically couple with the second plurality of docking magnets when the tablet computer is docked to the first portion 206 of the tablet computer case 204. According to at least some embodiments, the first plurality of docking magnets 306 have North-South orientations and pairings of magnets which correspond (e.g., are magnetically attracted to) North-South orientations and pairings of magnets of the second plurality of docking magnets. The first plurality of docking magnets 306 are configured to dock and align the tablet computer to the tablet computer case 204. In various embodiments, the magnetic force of the first plurality of docking magnets 306 is between 20 N and 25 N, inclusive. In at least some embodiments, the magnetic force of the first plurality of docking magnets 306 is 23 N.

According to some embodiments described herein, the first plurality of docking magnets 306 includes at least three groups on the first lateral side and the second lateral side of the tablet computer case 204 that are oriented horizontally and the fourth group that is oriented vertically. Having a majority of the groups of magnets on each side of the tablet computer case 204 oriented in the horizontal direction provides stability to the system, especially during button presses on a docked tablet computer. For example, a button press may include a user is interacting with buttons along the top edge of the tablet computer. Horizontally oriented groups increase the magnetic strength in the y-direction such that any tipping resulting from interacting with a top edge or corner of the electronic device is minimized. The outermost three groups on the first lateral side and the second lateral side include alternating north and south polarity across (e.g., from left to right) the three outermost three groups. The alternating polarity further prevents false home occurrences and misalignment of the electronic device and the dock by reducing the number of available magnets in the correct orientation (e.g., such that the magnets would be attracted to one another) being in close proximity to one another. The resulting docking experience is a fluid movement from bringing the electronic device in proximity to the dock and the magnetic coupling of the electronic device and the dock. The fluid docking movement may be substantially in the horizontal direction as the majority of the magnets placed in the horizontal direction guide the electronic device across the surface of the dock into the electronic device's final docking position.

The vertically oriented groups of magnets of the first plurality of docking magnets 306 facilitate alignment of electrical contact pads of the tablet computer and pins of the tablet computer case 204. The vertically oriented groups of magnets further guide the tablet computer vertically into position on the surface of the tablet computer case 204 such as when the tablet computer is brought slightly above or below the arrangement of magnets, specifically, the horizontally aligned outermost three groups.

According to various embodiments, the first pivot magnets 304 are relatively stronger (e.g., have a higher magnetic force) than the first plurality of docking magnets 306. The first pivot magnets 304 provide a fine-tuned alignment of the tablet computer to the tablet computer case 204 such that any apertures 307 (e.g., camera holes, speaker holes, etc.) align with corresponding cameras, speakers, etc., of the tablet computer. In some embodiments, the first plurality of docking magnets 306 are insufficient to maintain the tablet computer docked to the tablet computer case 204 without the first pivot magnets 304.

According to at least some embodiments, the second portion 208 of the tablet computer case 204 includes latching magnets 308. The latching magnets 308 are configured to latch to a first pivot magnet 304 on the first portion 206 of the tablet computer case 204 and the second pivot magnet 402 of the tablet computer 202 (to be described in further detail below) when the tablet computer case 204 is in the closed position and the tablet computer is docked to the tablet computer case 204. In other embodiments, the latching magnets 308 may be configured to latch to a first pivot magnet 304 on the first portion 206 when the tablet computer case 204 is in the closed position and there is no tablet computer docked to the tablet computer case 204. For example, the latching magnets 308 magnetically couple to the first pivot magnet 304 in the absence of a tablet computer. Accordingly, the first pivot magnets 304 have a dual function where the first pivot magnets 304 are configured to direct docking and undocking of a tablet computer to the tablet computer case 204 and are further configured to latch the tablet computer case 204 in a closed position, with or without the tablet computer docked to the tablet computer case 204. In yet other embodiments, the latching magnets 308 are not aligned with the first pivot magnet 304 on the first portion 206 of the tablet computer case 204. For example, the latching magnets 308 are located in a different location along the second portion 208 than a position that aligns with the pivot magnet 304 (e.g., in contrast to the arrangement shown in FIG. 3). In exemplary embodiments, the tablet computer 202 may include additional latching magnets (e.g., in addition to a second pivot magnet) that correspond to latching magnets 308 and do not align with the first pivot magnet 304 when the tablet computer 202 is docked to the tablet computer case 204.

In various embodiments, and as shown in FIG. 3, the second portion 208 of the tablet computer case 204 includes at least two latching magnets 308. For example, the second portion 208 includes a latching magnet for each first pivot magnet 304. In various embodiments, the magnetic latching force in a stack including the first pivot magnet 304, the second pivot magnet in the tablet computer, and the latching magnets 308 is between 5 N and 10 N, inclusive. In at least some embodiments, the magnetic latching force is 6.5 N.

According to various embodiments of the present disclosure, any of the magnets described herein may be neodymium magnets. In other embodiments, any of the magnets may include any material or combination of materials. Magnets having different functions may include different materials or different combinations of materials. For example, docking magnets may include different material(s) than pivot magnets.

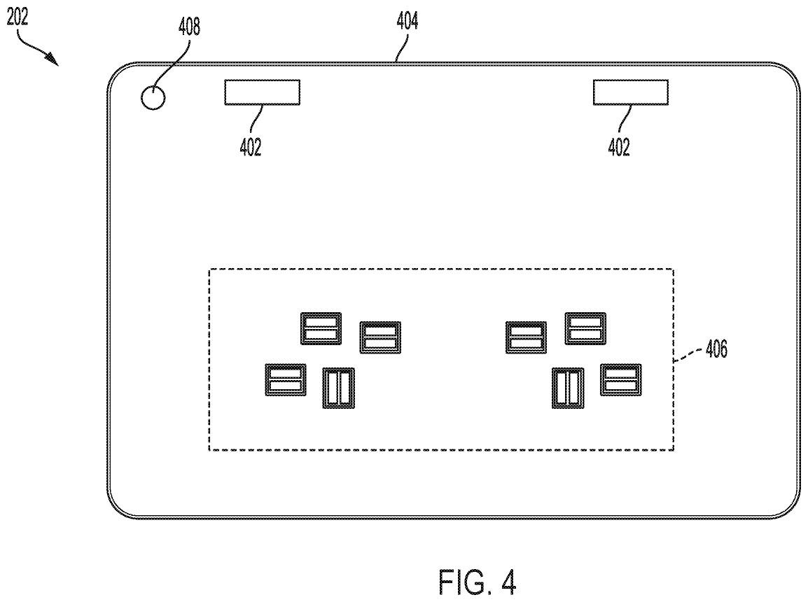

FIG. 4 illustrates an embodiment of a tablet computer having a second plurality of docking magnets and second pivot magnets. The description of tablet computer case system 200 and the tablet computer case 204 described in relation to FIGS. 2-3 is applicable to the tablet computer having a second plurality of docking magnets and second pivot magnets. The tablet computer 202 includes a second pivot magnet 402 arranged proximate to a topmost edge 404 of the tablet computer 202. According to at least some embodiments, the tablet computer 202 includes at least two second pivot magnets 402, as shown in FIG. 4. A topmost edge 404 of the tablet computer 202 aligns with the topmost edge 302 of the first portion 206 of the tablet computer case 204, as described in detail with respect to FIG. 3, when the tablet computer 202 is docked to the tablet computer case 204 as would be appreciated by one having ordinary skill in the art upon reading the present disclosure.

According to various embodiments, the second pivot magnets 402 are configured to magnetically couple to the first pivot magnets 304 when the tablet computer 202 is docked to the tablet computer case 204. For example, the second pivot magnets 402 of the tablet computer 202 magnetically couple with the first pivot magnets 304 of the tablet computer case 204 when the tablet computer 202 is docked to the first portion 206 of the tablet computer case 204.

The second pivot magnets 402 act as the first points of contact for a tablet computer 202 being docked to the tablet computer case 204. The second pivot magnets 402 provide a concentrated magnetic force which initially draws the tablet computer 202 toward the tablet computer case 204. According to at least some embodiments of the present disclosure, the second pivot magnets 402 provide additional concentrated magnetic force proximate to the topmost edge 404 of the tablet computer 202. In various embodiments, the magnetic force for assisted docking provided by the second pivot magnets 402 is between 20 N and 25 N, inclusive. In at least some embodiments, the magnetic force for assisted docking provided by the second pivot magnets 402 is 20 N.

In various embodiments, the tablet computer 202 includes a second plurality of docking magnets 406 arranged on the tablet computer 202. The second plurality of docking magnets 406 are arranged to magnetically couple to the first plurality of docking magnets 306, as described in detail above. The second plurality of docking magnets 406 are configured to magnetically couple with the first plurality of docking magnets 306 of the tablet computer case 204, when the tablet computer 202 is docked to the tablet computer case 204. For example, the second plurality of docking magnets 406 magnetically couple with the first plurality of docking magnets 306 when the tablet computer 202 is docked to the first portion 206 of the tablet computer case 204. The second plurality of docking magnets 406 are configured to dock and align the tablet computer 202 to the tablet computer case 204. In various embodiments, the magnetic force of the second plurality of docking magnets 406 is between 20 N and 25 N, inclusive. In at least some embodiments, the magnetic force of the second plurality of docking magnets 406 is 23 N.

According to various embodiments, the second pivot magnets 402 are relatively stronger (e.g., have a higher magnetic force) than the second plurality of docking magnets 406. The second pivot magnets 402 provide a fine-tuned alignment of the tablet computer 202 to the tablet computer case 204 such that any cameras, speakers, etc., of the tablet computer 202, such as camera 408, align with corresponding camera holes, speaker holes, etc., such as aperture 307 of the tablet computer case 204. In some embodiments, second plurality of docking magnets 406 are insufficient to maintain the tablet computer 202 docked to the tablet computer case 204 without the second pivot magnets 402.

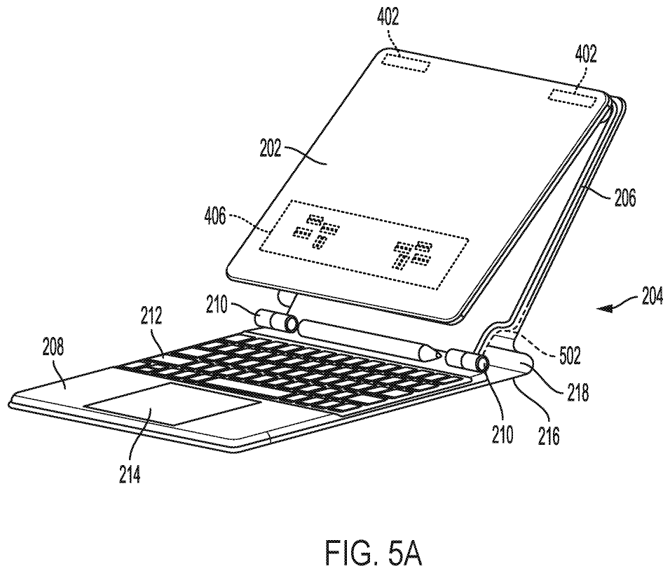

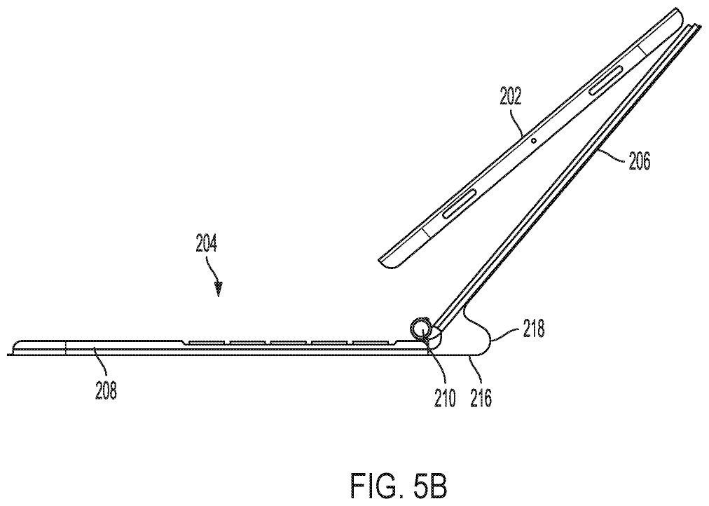

FIG. 5A is a perspective view of an embodiment of a tablet computer mid-docking/undocking from a tablet computer case. The description of tablet computer case system 200, the tablet computer case 204, and the tablet computer 202 described in relation to FIGS. 2-4 is applicable to the perspective view of an embodiment of a tablet computer mid-docking/undocking from a tablet computer case. As shown, that tablet computer 202 is being docked to the tablet computer case 204, or alternatively, the tablet computer 202 is being undocked from the tablet computer case 204.

Docking and undocking may be a two-part action. For example, during undocking, a user grasps an edge, preferably a bottommost edge closest to the hinge, of the tablet computer 202. The first plurality of docking magnets (not shown) of the tablet computer case 204 magnetically decouple from the second plurality of docking magnets 406 of the tablet computer 202, and vice versa. Following the magnetic decoupling of the docking magnets, the tablet computer 202 pivots away from the tablet computer case 204 where the first pivot magnets (not shown) of the tablet computer case 204 remain magnetically coupled to the second pivot magnets 402 to cause the tablet computer 202 to rotate with respect to the first portion 206 of the tablet computer case 204. For example, after the first plurality of docking magnets have been disengaged from the tablet computer 202, e.g., the second plurality of docking magnets 406 of the tablet computer 202, the first pivot magnets remain engaged with the second pivot magnets 402 to cause the tablet computer 202 to rotate with respect to the first portion 206.

During docking, a user brings a tablet computer 202 proximate to a first portion 206 of the tablet computer case 204. The second pivot magnets 402 are drawn to the first pivot magnets (not shown) of the tablet computer case 204. The second pivot magnets 402 magnetically couple to the first pivots magnets before the second plurality of docking magnets 406 magnetically couple to the first plurality of docking magnets, and vice versa.

Visible in this view, the first portion 206 of the tablet computer case 204 may include a rigid material having a cutout 502 on each side of the first portion 206. The cutout 502 may be interchangeably referred to as an access feature, according to at least some embodiments. The cutout 502 creates a gap between the tablet computer 202 and the support feature 218 formed by the outer covering 216 in the open position. The cutouts 502 enable a user to easily grasp a bottom portion of the tablet computer 202 and further facilitate a smooth docking and undocking experience.

Docking and undocking may be described with respect to levers (specifically, class II levers) having a fulcrum at one end and a lifting force applied at the other end with a load disposed between the two ends. According to some embodiments, the center of mass of the tablet computer 202 docked to the tablet computer case 204 acts as the load on the lever. A lifting force applied by the user is opposite the fulcrum and is used to pivot the center of mass about the fulcrum (e.g., the pivot magnets).

FIG. 5B is a side view of an embodiment of a tablet computer mid-docking/undocking from a tablet computer case. The description of tablet computer case system 200, the tablet computer case 204, and the tablet computer 202 described in relation to FIGS. 2-5A is applicable to the side view of an embodiment of a tablet computer mid-docking/undocking from a tablet computer case. FIG. 5B is a side view of the tablet computer 202 mid-docking/undocking from the tablet computer case 204 as illustrated and described with respect to FIG. 5A. As shown, the pivot magnets create a “phantom hinge” about which the tablet computer 202 rotates during docking and undocking from the tablet computer case 204. As shown, that tablet computer 202 is being docked to the tablet computer case 204, or alternatively, the tablet computer 202 is being undocked from the tablet computer case 204.

As shown from the side view of FIG. 5B, during undocking, a bottommost edge closest to the hinge, of the tablet computer 202 is the first portion of the tablet computer 202 that is drawn away from the tablet computer case 204. The first plurality of docking magnets (not shown) of the tablet computer case 204 magnetically decouple from the second plurality of docking magnets 406 of the tablet computer 202, and vice versa. Following the magnetic decoupling of the docking magnets, the tablet computer 202 pivots away from the tablet computer case 204 where the first pivot magnets (not shown) of the tablet computer case 204 remain magnetically coupled to the second pivot magnets 402 to cause the tablet computer 202 to rotate with respect to the first portion 206 of the tablet computer case 204. For example, after the first plurality of docking magnets have been disengaged from the tablet computer 202, e.g., the second plurality of docking magnets 406 of the tablet computer 202, the first pivot magnets remain engaged with the second pivot magnets 402 to cause the tablet computer 202 to rotate with respect to the first portion 206.

During docking, a topmost edge of the tablet computer 202 is the first portion of the tablet computer 202 that is drawn to a first portion 206 of the tablet computer case 204. The second pivot magnets 402 are drawn to the first pivot magnets (not shown) of the tablet computer case 204. The second pivot magnets 402 magnetically couple to the first pivots magnets before the second plurality of docking magnets 406 magnetically couple to the first plurality of docking magnets, and vice versa.

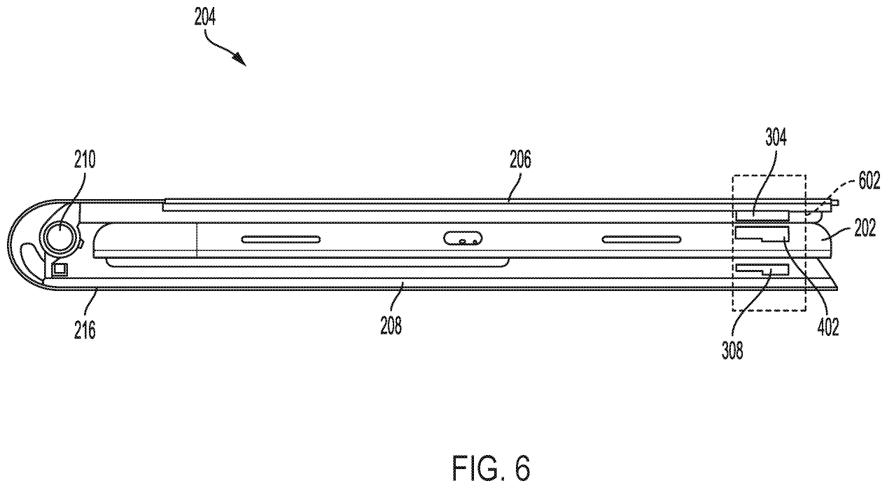

FIG. 6 is a side view of an embodiment of a tablet computer docked in a tablet computer case when the tablet computer case is in a closed position. The description of tablet computer case system 200, the tablet computer case 204, and the tablet computer 202 described in relation to FIGS. 2-5B is applicable to the side view of an embodiment of a tablet computer docked in a tablet computer case when the tablet computer case is in a closed position. As shown in this view, when the tablet computer 202 is docked to the tablet computer case 204 and the tablet computer case 204 is in the closed position, a magnet stack 602 is formed. The magnet stack 602 includes the first pivot magnets 304 which align and magnetically couple with the second pivot magnets 402 which may further magnetically couple to the latching magnets 308. The second pivot magnet 402 may be stacked between the first pivot magnet 304 and one of the latching magnets 308 when the tablet computer 202 is docked to the tablet computer case 204 and the tablet computer case 204 is in the closed position. The magnet stack 602 maintains the tablet computer case 204 in the closed position and further maintains the tablet computer 202 docked to the tablet computer case 204.

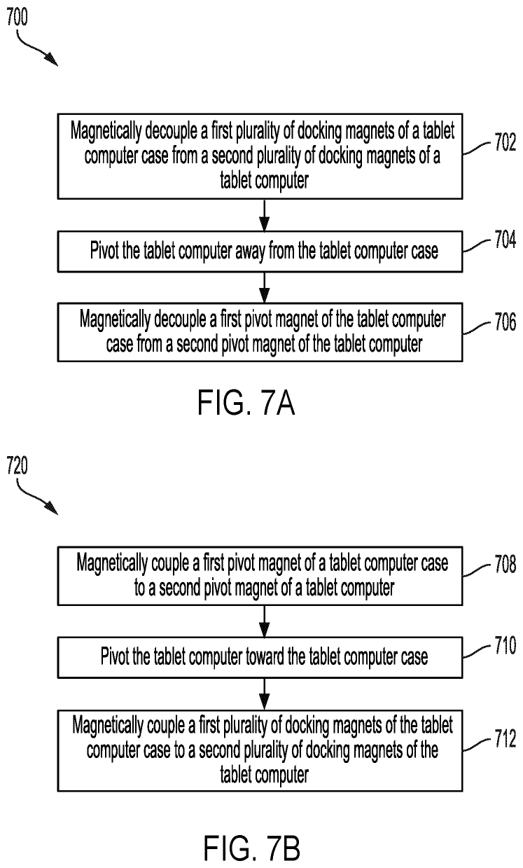

FIG. 7A illustrates a flowchart of an embodiment of a method. Method 700 includes step 702. Step 702 includes magnetically decoupling a first plurality of docking magnets of a tablet computer case from a second plurality of docking magnets of a tablet computer. For example, step 702 may include providing a tablet computer case including a first portion and a second portion including a keyboard. The second portion is configured to move relative to the first portion via a hinge for rotationally adjusting the position of the first and second portions relative to one another between an open position and a closed position. The tablet computer case includes a first plurality of docking magnets arranged on the first portion and a first pivot magnet arranged along a perimeter of the first portion opposite the hinge. The tablet computer case may include any of the embodiments described herein, such as tablet computer case 204 described with respect to other FIGS. Furthermore, step 702 may include providing a tablet computer including a second plurality of docking magnets arranged to magnetically couple to the first plurality of docking magnets and a second pivot magnet arranged to magnetically couple to the first pivot magnet. The tablet computer may include any of the embodiments described herein, such as tablet computer 202 described with respect to other FIGS. The first plurality of docking magnets of the tablet computer case magnetically decouple from the second plurality of docking magnets of the tablet computer, and vice versa.

Step 704 includes pivoting the tablet computer away from the tablet computer case. For example, during undocking, a user grasps an edge, preferably a bottommost edge closest to the hinge, of the tablet computer and lifts the bottom portion of the tablet computer away from the tablet computer case. Following the magnetic decoupling of the docking magnets, the tablet computer pivots away from the tablet computer case where the first pivot magnets of the tablet computer case remain magnetically coupled to the second pivot magnets to cause the tablet computer to rotate with respect to the first portion of the tablet computer case. For example, after the first plurality of docking magnets have been disengaged from the tablet computer, e.g., the second plurality of docking magnets of the tablet computer, the first pivot magnets remain engaged with the second pivot magnets to cause the tablet computer to rotate with respect to the first portion. The first pivot magnet and the second pivot magnets remain magnetically coupled such that the tablet computer is rotated relative to the first portion of the tablet computer case.

Step 706 includes magnetically decoupling a first pivot magnet of the tablet computer case from a second pivot magnet of the tablet computer. The pivot magnets remain engaged until all the docking magnets have been disengaged, according to some embodiments. Accordingly, a top edge of the tablet computer remains coupled to the top edge of the tablet computer case. Undocking may conclude with the first pivot magnet magnetically decoupling from the second pivot magnet, and vice versa.

In some embodiments, the tablet computer case includes an outer covering surrounding the hinge and the first and second portions. The outer covering forms a support feature while in the open position. According to at least some embodiments, the first portion of the tablet computer case includes a cutout on each side where a gap is formed between the tablet computer and the outer covering, e.g., a support feature formed by the outer covering in the open position. The gap creates a space for a user to easily insert fingers to grasp the tablet computer and to pivot the tablet computer away from the tablet computer case.

FIG. 7B illustrates a flowchart of an embodiment of a method. Method 720 includes step 708. Step 708 includes magnetically coupling a first pivot magnet of a tablet computer case to a second pivot magnet of a tablet computer. For example, step 708 may include providing a tablet computer case including a first portion and a second portion including a keyboard. The second portion is configured to move relative to the first portion via a hinge for rotationally adjusting the position of the first and second portions relative to one another between an open position and a closed position. The tablet computer case includes a first plurality of docking magnets arranged on the first portion and a first pivot magnet arranged along a perimeter of the first portion opposite the hinge. The tablet computer case may include any of the embodiments described herein, such as tablet computer case 204 described with respect to other FIGS. Furthermore, step 708 may include providing a tablet computer including a second plurality of docking magnets arranged to magnetically couple to the first plurality of docking magnets and a second pivot magnet arranged to magnetically couple to the first pivot magnet. The tablet computer may include any of the embodiments described herein, such as tablet computer 202 described with respect to other FIGS.

Step 710 includes pivoting the tablet computer toward the tablet computer case. For example, during docking, a topmost edge of the tablet computer is the first portion of the tablet computer that is drawn to a first portion of the tablet computer case. The second pivot magnets are drawn to the first pivot magnets of the tablet computer case. The second pivot magnets magnetically couple to the first pivots magnets before the second plurality of docking magnets magnetically couple to the first plurality of docking magnets, and vice versa.

Step 712 includes magnetically coupling a first plurality of docking magnets of the tablet computer case to a second plurality of docking magnets of the tablet computer. The second plurality of docking magnets are configured to magnetically couple with the first plurality of docking magnets of the tablet computer case when the tablet computer is docked to the tablet computer case. For example, the second plurality of docking magnets magnetically couple with the first plurality of docking magnets when the tablet computer is docked to the first portion of the tablet computer case. The second plurality of docking magnets are configured to dock and align the tablet computer to the tablet computer case.

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known, processes, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

What is claimed is:

1. A method for docking a tablet computer to a tablet computer case comprising:
magnetically coupling a first pivot magnet of the tablet computer case to a second pivot magnet of the tablet computer;
pivoting the tablet computer toward the tablet computer case; and
magnetically coupling a first plurality of docking magnets of the tablet computer case to a second plurality of docking magnets of the tablet computer, wherein the first pivot magnet magnetically couples to the second pivot magnet prior to the first plurality of docking magnets magnetically coupling to the second plurality of docking magnets.

2. The method of claim 1, further comprising undocking the tablet computer from the tablet computer case comprising:
magnetically decoupling the second plurality of docking magnets of the tablet computer from the first plurality of docking magnets of the tablet computer case;
pivoting the tablet computer toward the tablet computer case; and
magnetically decoupling the first pivot magnet of the tablet computer case from the second pivot magnet of the tablet computer case, wherein the first plurality of docking magnets magnetically decouple from the second plurality of docking magnets prior to the first pivot magnet magnetically decoupling from the second pivot magnet.

3. The method of claim 1, wherein the first pivot magnet is arranged proximate to a topmost edge of the tablet computer case.

4. The method of claim 3, wherein a portion of the tablet computer case proximate to the topmost edge of the tablet computer case is a first point of contact for docking the tablet computer to the tablet computer case.

5. The method of claim 4, wherein the portion of the tablet computer case proximate to the topmost edge of the tablet computer case is a pivot point for undocking the tablet computer from the tablet computer case.

6. The method of claim 1, further comprising closing the tablet computer case such that a latching magnet of the tablet computer case arranged opposite the first pivot magnet and the second pivot magnet magnetically couples to the first pivot magnet and the second pivot magnet to latch the tablet computer case in a closed position.

7. A tablet computer case system comprising:
a tablet computer case comprising:
a first portion;
a second portion comprising a keyboard, the second portion configured to move relative to the first portion;
a hinge for rotationally adjusting a position of the first and second portions relative to one another between an open position and a closed position;
a first plurality of docking magnets arranged on the first portion; and
a first pivot magnet arranged along a perimeter of the first portion opposite the hinge,
wherein after the first plurality of docking magnets have been disengaged from magnetically coupling with a tablet computer, the first pivot magnet remains engaged with the tablet computer to cause the tablet computer to rotate with respect to the first portion.

8. The tablet computer case system of claim 7, further comprising the tablet computer that can be removably docked from the first portion of the tablet computer case, the tablet computer comprising:
a second plurality of docking magnets arranged to magnetically couple to the first plurality of docking magnets; and
a second pivot magnet arranged to magnetically couple to the first pivot magnet.

9. The tablet computer case system of claim 7, further comprising: a latching magnet arranged on the second portion.

10. The tablet computer case system of claim 8, wherein the first pivot magnet is arranged to magnetically couple to the second pivot magnet on the tablet computer.

11. The tablet computer case system of claim 9, wherein the second pivot magnet is stacked between the first pivot magnet and the latching magnet when the tablet computer is docked to the tablet computer case and the tablet computer case is in the closed position.

12. The tablet computer case system of claim 7, wherein the first pivot magnet enables a two-part docking and undocking of the tablet computer from the tablet computer case.

13. The tablet computer case system of claim 7, further comprising an outer covering surrounding the hinge and the first and second portions, the outer covering forming a support feature while in the open position.

14. The tablet computer case system of claim 13, further comprising an access feature on each side of the first portion, wherein a gap to facilitate undocking is formed between the support feature and the access feature when the tablet computer case is in the open position.

15. The tablet computer case system of claim 7, wherein the tablet computer case comprises at least two first pivot magnets and the tablet computer comprises at least two second pivot magnets.

16. A tablet computer case comprising:
a first portion that is removably dockable with a tablet computer;
a second portion comprising a keyboard, the second portion configured to move relative to the first portion;
a hinge for rotationally adjusting a position of the first and second portions relative to one another between an open position and a closed position;
a first plurality of docking magnets arranged on the first portion to magnetically couple to a second plurality of docking magnets on the tablet computer; and
a first pivot magnet arranged along a perimeter of the first portion opposite the hinge to magnetically couple with a second pivot magnet on the tablet computer.

17. The tablet computer case of claim 16, further comprising: a latching magnet arranged on the second portion.

18. The tablet computer case of claim 16, wherein the first pivot magnet is arranged to magnetically couple to a second pivot magnet on the tablet computer.

19. The tablet computer case of claim 17, wherein the second pivot magnet is stacked between the first pivot magnet and the latching magnet when the tablet computer is docked to the tablet computer case and the tablet computer case is in the closed position.

20. The tablet computer case of claim 16, wherein the first pivot magnet enables a two-part docking and undocking of the tablet computer from the tablet computer case.
